(19) United States
(12) Patent Application Publication
(10) Pub. No.: US 2014/0089481 A1
(43) Pub. Date: Mar. 27, 2014

(54) DEVICE BROKER WITH DYNAMIC CONNECTIVITY DETERMINATION

(71) Applicants: Timothy Verrall, Pleasant Hill, CA (US); William M. Cox, Hillsboro, OR (US); Travis V. Broughton, Austin, TX (US); Carol A. Wilder, Portland, OR (US)

(72) Inventors: Timothy Verrall, Pleasant Hill, CA (US); William M. Cox, Hillsboro, OR (US); Travis V. Broughton, Austin, TX (US); Carol A. Wilder, Portland, OR (US)

(21) Appl. No.: 13/628,124

(22) Filed: Sep. 27, 2012

(51) Int. Cl. G06F 15/173

(52) U.S. Cl. 709/223

(57) ABSTRACT

Generally, this disclosure provides methods, systems and devices for dynamic determination of connectivity to a device, for example device brokering, based on a context state of the device. The method may include maintaining a user policy database configured to store connectivity rules, the connectivity rules associated with the user and one or more of the user devices; logging registration data received from the user device, the registration data indicating a context state associated with the user device; receiving a request from a remote party to connect to the user; and selecting one or more of the user devices for the connection to the remote party, the selection based on the context state and the user policy connectivity rules.

### FIELD

The present disclosure relates to device brokers, and more particularly, to device brokers with dynamic connectivity determination.

### BACKGROUND

Existing communication systems provide the capability for a single telephone number, or other point of contact, to be associated with multiple communication devices associated with a user. For example, if someone sends a text message to a single user, that text message may be delivered to all of the devices associated with that user which are enabled to receive text messages. The same holds true for a voice call or any other method of communication or notification. This duplication of message notification and/or delivery may detract from the quality of the user experience and generally decreases network efficiency.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates a block diagram of another exemplary embodiment consistent with the present disclosure;

FIG. 4 illustrates a flowchart of operations of an exemplary embodiment consistent with the present disclosure;

FIG. 5 illustrates a system diagram showing mobile platforms consistent with an exemplary embodiment of the present disclosure in a network; and

FIG. 6 illustrates a flowchart of operations of another exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides methods, systems and devices for dynamic determination of connectivity to a device, for example device brokering, based on a context state of the device. In response to receiving a request to communicate with a user, for example from a remote party, the device broker may determine which of the user's multiple devices will be used to establish the communication link. Communication requests may include, for example, text messages, voice calls, video calls and/or notifications of any type. The determination may be made based on the context state of the devices in conjunction with rules stored in a user policy database which indicate user connectivity preferences. Context may include, for example, activity state, location and/or available types of connectivity for the device. The context state of the devices may be registered or reported to the device broker from the devices based on sensor data within the devices. Device sensor data may include, for example, power state, motion, location and keyboard or screen activity.

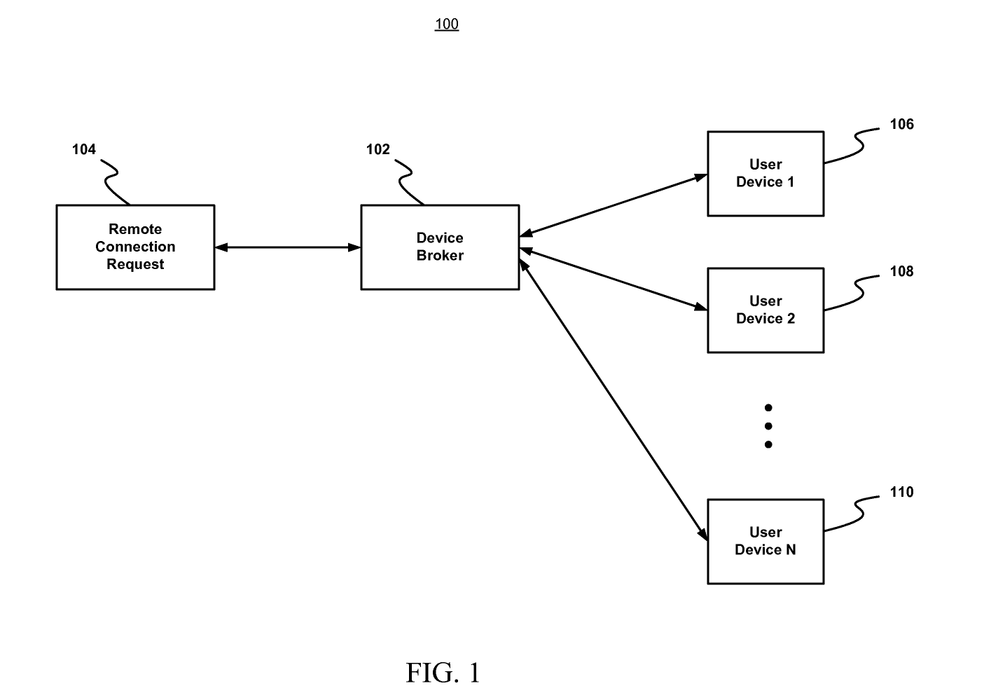

FIG. 1 illustrates a top level system diagram 100 of one exemplary embodiment consistent with the present disclosure. A device broker 102 receives a remote connection request 104 from a remote party. The connection request may be a request to deliver a message or information content to a user or to establish a call between the remote party and the user. The user may have, or be associated with, one or more user devices 106, 108, 110 which share a common phone number or contact point. The devices may include phones, smartphones, laptops, tablets, smart televisions, desktops, workstations or any type of wired or wireless communication device or platform. The device broker 102 selects one or more of the user devices 106, 108, 110 to complete the connection by, for example, delivering a text message or routing a call to that device. The device broker 102 may select the device based on a context state of that device and user preference or policy rules. Context may include, for example, activity state, location and/or types or classes of connectivity available to the device. Classes of connectivity may include, for example, physical and/or electrical characteristics of a network interface that are associated with speed, reliability, convenience, etc of a connection.

It will be appreciated that connection requests may also be routed to non-physical or abstract devices such as voicemail (e.g., a voicemails server), a social media web page or any type of internet or cloud service. Similarly, connection requests, in addition to phone calls, video calls, voicemails, text messages and pings may comprise any type of notification including cloud application alerts (e.g., weather alerts, airline reservation/flight status updates, stock price updates, sports scores, etc.) or alerts from any cloud-registered application requesting bulk, mediated delivery.

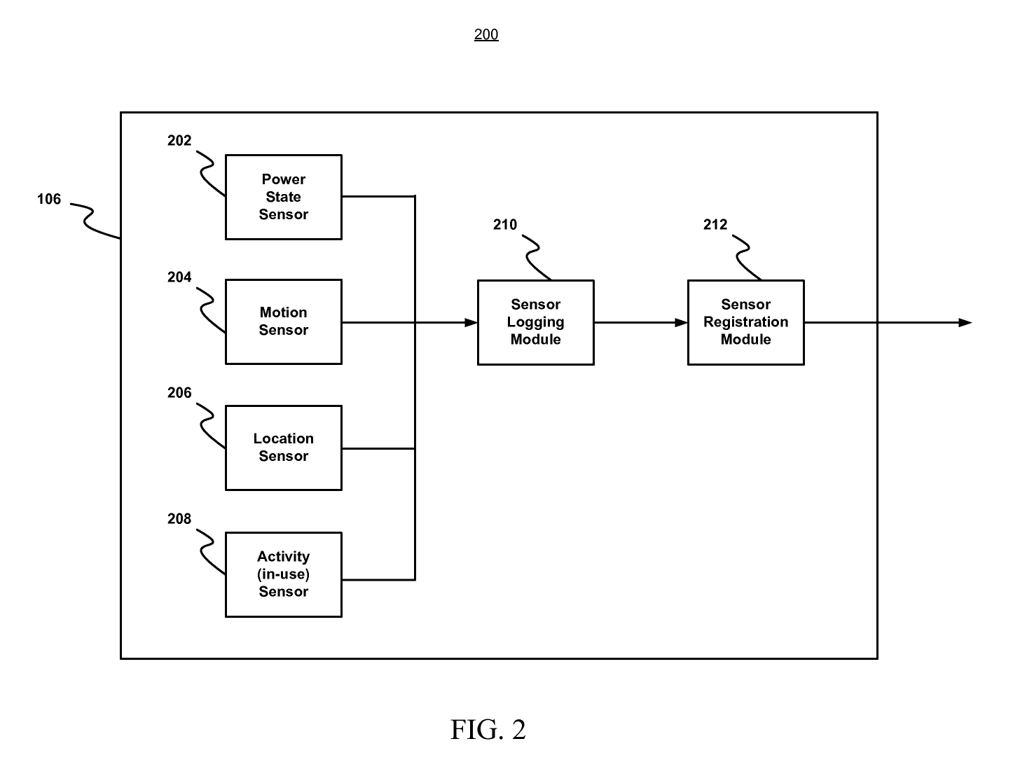

FIG. 2 illustrates a block diagram 200 of one exemplary embodiment consistent with the present disclosure. A user device 106 is shown to comprise a number of context sensors including a power state sensor 202, a motion sensor 204, a location sensor 206, and an activity or in-use sensor 208. User device 106 also comprises a sensor logging module 210 and a sensor registration module 212. Power state sensor 202 may be configured to determine the power state of the device 106. Power states may include, for example, whether the device is powered on or off, or in a sleep or hibernation state or any other state that may be useful for estimating whether the device is in-use or not. Motion sensor 204 may be configured to determine whether the device is in motion. In some embodiments, the motion sensor 204 may be an accelerometer, a global positioning system (GPS) receiver or any other sensor suitable for estimating motion. Location sensor 206 may be configured to determine the location of the device. In some embodiments, the location sensor 206 may be a GPS receiver or any other sensor suitable for estimating location. Motion and/or location information may be useful, for example, to indicate that the device is in proximity to the user which may be a factor in determining the context state of the device. Activity, or in-use, sensor 208 may be configured to monitor activity on the input/output or user interface components of the device, such as, for example, the screen, keypad, speaker or microphone.

Sensor logging module 210 may be configured to log data collected from sensors 202, 204, 206, 208. The data may be logged at periodic intervals or when state changes are detected in the sensors. In some embodiments, the sensor data may be time stamped. Sensor registration module 212 may be configured to report the sensor data collected by sensor logging module 210 to device broker 102. The reports may be transmitted at periodic intervals or may be transmitted in response to an upload request from the device broker. In some embodiments, the modules, including sensor logging module 210 and sensor registration module 212, may be implemented in any combination of hardware, firmware or software (including operating system or application software).

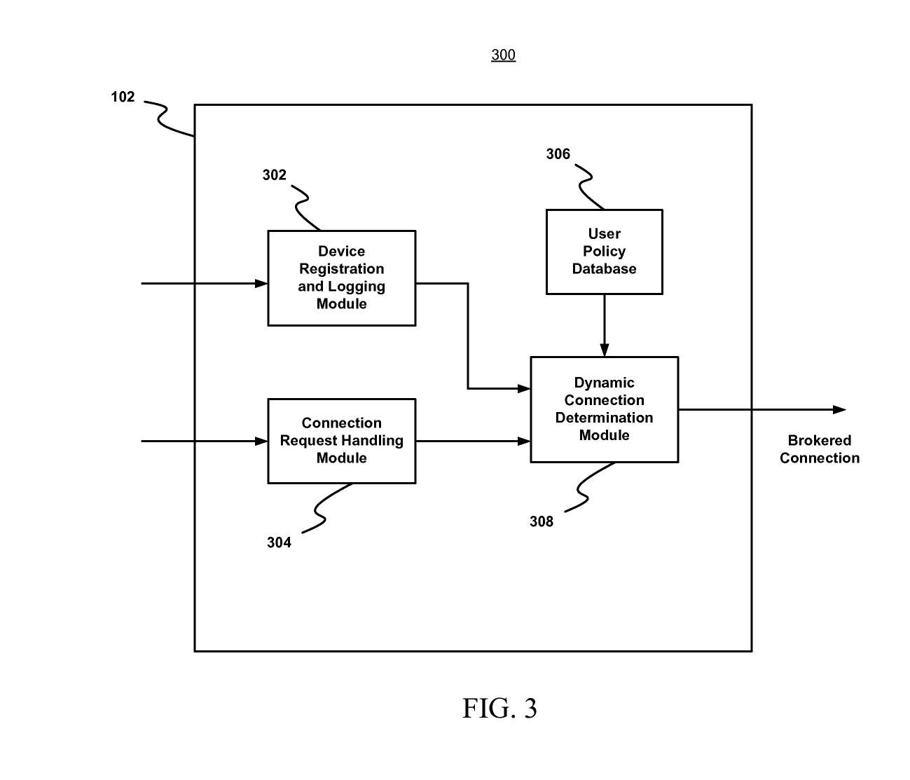

FIG. 3 illustrates a block diagram 300 of another exemplary embodiment consistent with the present disclosure. Device broker 102 is shown to comprise device registration and logging module 302, connection request handling module 304, user policy database 306 and dynamic connection determination module 308. Device registration and logging module 302 may be configured to receive sensor data reports, or registrations, from user devices 106, 108, 110 and maintain this information in a form that is available to dynamic connection determination module 308 for determining device context status. In some embodiments, the device registration and logging module 302 may transmit registration requests to the user devices and receive a data upload in response to the request.

Connection request handling module 304 may be configured to receive a remote connection request 104 from a remote party. The connection request may be a request to deliver a message or information content to a user, to establish a call between the remote party and the user or to provide any type of notification to the user as previously described. User policy database 306 may be configured to store user preferences and rules for device connectivity. For example, a user may request that calls be routed to the user's laptop while text messages are routed to the user's mobile phone. As another example, the user may request that all connections be made to the user's phone if the phone is located in a specified area. As yet another example the user may request that messages and calls be directed to a second device while a first device is in use. As a further example, a user policy may request that connections be routed to the user's desktop computer (which may be configured with power and activity sensors) during working hours or while in use.

The user may specify a default rule selecting a particular device to be connected in the case that all user devices are determined to be inactive. While these examples are provided for illustrative purposes, it will be appreciated that the rules or policies may specify any combination of connections to any combination of devices based on any combination of available context, activity or sensor data.

In response to receiving a connection request, dynamic connection determination module 308 may determine which of user devices 106, 108, 110 will be selected for the connection, i.e. a connection is brokered. The determination may be based on an estimation of the context status of the devices, from the logged device registration data, in conjunction with the user preferences obtained from the user policy database 306. In some embodiments, a device that is currently in-use or most recently in-use may be selected.

In some embodiments, the modules, including device registration and logging module 302, connection request handling module 304, user policy database 306 and dynamic connection determination module 308, may be implemented in any combination of hardware, firmware or software (including operating system or application software).

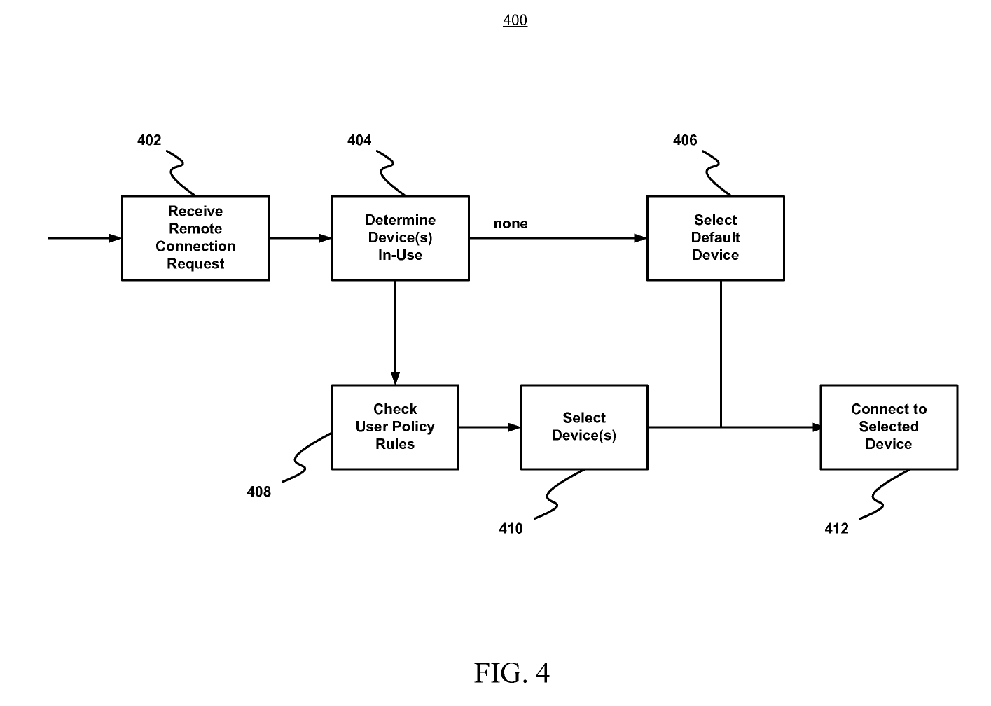

FIG. 4 illustrates a flowchart of operations 400 of an exemplary embodiment consistent with the present disclosure. At operation 402, a remote connection request is received. The connection request may be a request to deliver a message, information content or notification to a user or to establish a call between the remote party and the user. At operation 404, a determination is made as to which, if any, of the user's device may currently be in-use. In some embodiments the in-use determination may be expanded to include a broader device context such as location and available class of connectivity. At operation 406, if no device is currently in-use, a default device may be selected. At operation 408, the user policy rules are checked to determine user preferences for device selection under the current situation with regard to device context. At operation 410, one or more devices are selected. At operation 412, the selected devices are connected.

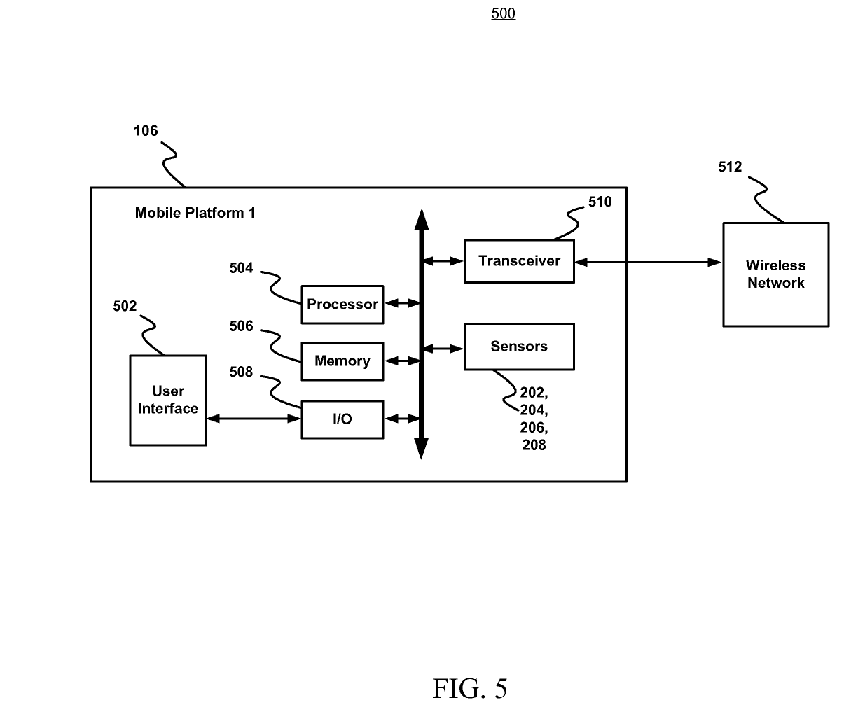

FIG. 5 illustrates a system diagram 500 showing mobile platforms consistent with an exemplary embodiment of the present disclosure in a network. An embodiment of a user device 106 as a mobile or wireless platform is shown. The mobile platform 106 may be a mobile communication device, such as, for example, a smartphone, a tablet, a laptop computing device or any other device configured to transmit or receive wireless signals. In some embodiments, platform 106 may comprise a processor 504, memory 506, an input/output (I/O) system 508, a speaker, microphone, display, keyboard or other type of user interface (UI) 502 such as, for example, a touchscreen. Platform 106 may also comprise a transceiver 510 configured for wireless communication over a network 512. Platform 106 may further comprise a number of context sensors 202, 204, 206, 208 as described previously. Any number of platforms 106 may transmit or receive signals over a network 512, to a device broker 102 as well as to remote connection requestors 104. It will be appreciated that in some alternative embodiments, the platform may be a stationary platform, such as, for example, a workstation or desktop computer. Similarly, the network interface may include an additional (or alternative) wired network interface.

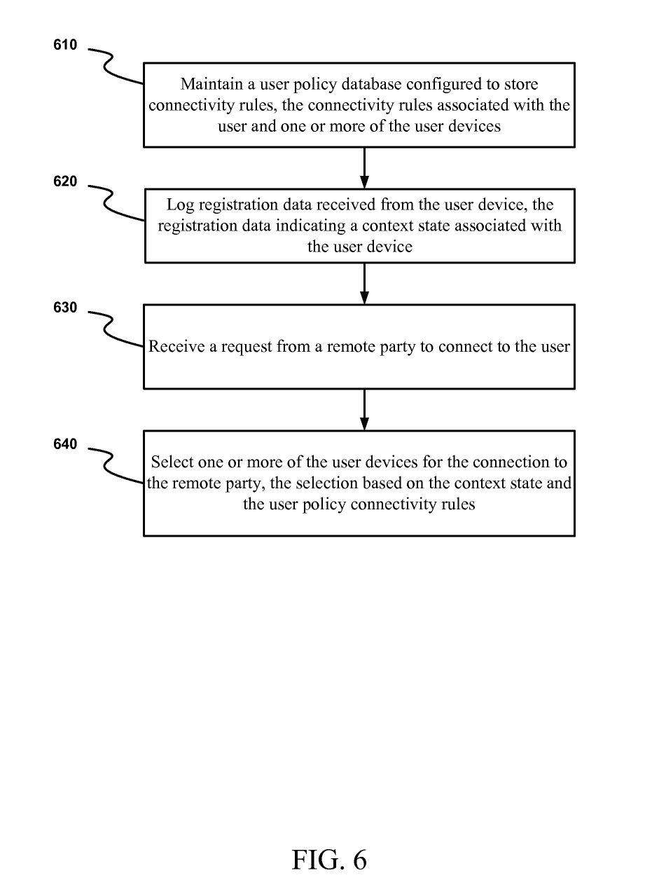

FIG. 6 illustrates a flowchart of operations 600 of an exemplary embodiment consistent with the present disclosure. At operation 610, a user policy database is maintained. The database is configured to store connectivity rules associated with the user and one or more of the user devices. At operation 620, registration data received from the user device is logged. The registration data indicates a context state associated with the user device. At operation 630, a request to connect to the user is received from a remote party. At operation 640, one or more of the user devices are selected for the connection to the remote party. The selection is based on the context state and the user policy connectivity rules.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides methods, systems and devices for dynamic determination of connectivity to a device, for example device brokering, based on a context state of the device.

The system may include a device logging module configured to log registration data received from the user device, the registration data indicating a context state associated with the user device. The system of this example may also include a connection request handling module configured to receive a request from a remote party to connect to the user. The system of this example may further include a user policy database configured to store connectivity rules, the connectivity rules associated with the user and one or more of the user devices. The system of this example may further include a dynamic connection determination module configured to select one or more of the user devices for the connection to the remote party, the selection based on the context state and the user policy connectivity rules.

Another example system includes the forgoing components and the context state includes an activity state, a location and an available connectivity class.

Another example system includes the forgoing components and the dynamic connection determination module is further configured to establish a connection between the remote party and the selected user device.

Another example system includes the forgoing components and the device logging module is further configured to request the registration data from the user device.

Another example system includes the forgoing components and the user policy connectivity rules include a default rule, the default rule identifying one or more of the user devices to be connected when the registration data indicates that all of the user devices are inactive.

Another example system includes the forgoing components and the user devices are a smartphone, a laptop, a tablet, a desktop computer, a voicemail server and/or a smart television.

Another example system includes the forgoing components and the user device is a cloud based service.

Another example system includes the forgoing components and the requests from a remote party are a phone call, a video call, a voice message, a text message and/or a notification from a cloud based application.

According to another aspect there is provided a method. The method may include maintaining a user policy database configured to store connectivity rules, the connectivity rules associated with the user and one or more of the user devices. The method of this example may also include logging registration data received from the user device, the registration data indicating a context state associated with the user device. The method of this example may further include receiving a request from a remote party to connect to the user. The method of this example may further include selecting one or more of the user devices for the connection to the remote party, the selection based on the context state and the user policy connectivity rules.

Another example method includes the forgoing operations and the context state includes an activity state, a location and an available connectivity class.

Another example method includes the forgoing operations and further includes establishing a connection between the remote party and the selected user device.

Another example method includes the forgoing operations and further includes requesting the registration data from the user device.

Another example method includes the forgoing operations and the user policy connectivity rules include a default rule, the default rule identifying one or more of the user devices to be connected when the registration data indicates that all of the user devices are inactive.

Another example method includes the forgoing operations and the user devices are a smartphone, a laptop, a tablet, a desktop computer, a voicemail server and/or a smart television.

Another example method includes the forgoing operations and the user device is a cloud based service.

Another example method includes the forgoing operations and the requests from a remote party are a phone call, a video call, a voice message, a text message and/or a notification from a cloud based application.

According to another aspect there is provided at least one computer-readable storage medium having instructions stored thereon which when executed by a processor, cause the processor to perform the operations of the method as described in the examples above.

According to another aspect there is provided a communication device. The communication device may include a context sensor configured to determine a context state associated with the device. The communication device may also include a logging and registration module coupled to the context sensor, the logging and registration module configured to log context state data provided by the context sensor and to register the context state data with a device connection determination system.

Another example communication device includes the forgoing components and the context sensor is a device power state sensor, a device motion sensor, a device location sensor, and/or a device in-use sensor.

Another example communication device includes the forgoing components and the in-use sensor is configured to detect activity on an input-output system of the device.

Another example communication device includes the forgoing components and the input-output system is a keypad, a screen, a speaker, and/or a microphone.

Another example communication device includes the forgoing components and the communication device is a smartphone, a laptop, a tablet, or a desktop computer.

Another example communication device includes the forgoing components and the logging and registration module is further configured to register the context state data in response to receiving a registration request from the device connection determination system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system for determining connectivity to a user device, said system comprising:
a device logging module configured to log registration data received from said user device, said registration data indicating a context state associated with said user device;
a connection request handling module configured to receive a request from a remote party to connect to said user;
a user policy database configured to store connectivity rules, said connectivity rules associated with said user and one or more of said user devices; and
a dynamic connection determination module configured to select one or more of said user devices for said connection to said remote party, said selection based on said context state and said user policy connectivity rules.

2. The system of claim 1, wherein said context state comprises an activity state, a location and an available connectivity class.

3. The system of claim 1, wherein said dynamic connection determination module is further configured to establish a connection between said remote party and said selected user device.

4. The system of claim 1, wherein said device logging module is further configured to request said registration data from said user device.

5. The system of claim 1, wherein said user policy connectivity rules comprise a default rule, said default rule identifying one or more of said user devices to be connected when said registration data indicates that all of said user devices are inactive.

6. The system of claim 1, wherein said user devices are selected from the group consisting of a smartphone, a laptop, a tablet, a desktop computer, a voicemail server and a smart television.

7. The system of claim 1, wherein said user device is a cloud based service.

8. The system of claim 1, wherein said requests from a remote party are selected from the group consisting of a phone call, a video call, a voice message, a text message and a notification from a cloud based application.

9. A method for determining connectivity to a user device, said method comprising:
maintaining a user policy database configured to store connectivity rules, said connectivity rules associated with said user and one or more of said user devices;
logging registration data received from said user device, said registration data indicating a context state associated with said user device;
receiving a request from a remote party to connect to said user; and
selecting one or more of said user devices for said connection to said remote party, said selection based on said context state and said user policy connectivity rules.

10. The method of claim 9, wherein said context state comprises an activity state, a location and an available connectivity class.

11. The method of claim 9, further comprising establishing a connection between said remote party and said selected user device.

12. The method of claim 9, further comprising requesting said registration data from said user device.

13. The method of claim 9, wherein said user policy connectivity rules comprise a default rule, said default rule identifying one or more of said user devices to be connected when said registration data indicates that all of said user devices are inactive.

14. The method of claim 9, wherein said user devices are selected from the group consisting of a smartphone, a laptop, a tablet, a desktop computer, a voicemail server and a smart television.

15. The method of claim 9, wherein said user device is a cloud based service.

16. The method of claim 9, wherein said requests from a remote party are selected from the group consisting of a phone call, a video call, a voice message, a text message and a notification from a cloud based application.

17. A computer-readable storage medium having instructions stored thereon which when executed by a processor result in the following operations for determining connectivity to a user device, said operations comprising:
maintaining a user policy database configured to store connectivity rules, said connectivity rules associated with said user and one or more of said user devices;
logging registration data received from said user device, said registration data indicating a context state associated with said user device;
receiving a request from a remote party to connect to said user; and
selecting one or more of said user devices for said connection to said remote party, said selection based on said context state and said user policy connectivity rules.

18. The computer-readable storage medium of claim 17, wherein said context state comprises an activity state, a location and an available connectivity class.

19. The computer-readable storage medium of claim 17, further comprising the operation of establishing a connection between said remote party and said selected user device.

20. The computer-readable storage medium of claim 17, further comprising the operation of requesting said registration data from said user device.

21. The computer-readable storage medium of claim 17, wherein said user policy connectivity rules comprise a default rule, said default rule identifying one or more of said user devices to be connected when said registration data indicates that all of said user devices are inactive.

22. A communication device comprising:
a context sensor configured to determine a context state associated with said device;
a logging and registration module coupled to said context sensor, said logging and registration module configured to log context state data provided by said context sensor and to register said context state data with a device connection determination system.

23. The communication device of claim 22, wherein said context sensor is selected from the group consisting of a device power state sensor, a device motion sensor, a device location sensor, and a device in-use sensor.

24. The communication device of claim 23, wherein said in-use sensor is configured to detect activity on an input-output system of said device.

25. The communication device of claim 24, wherein said input-output system is selected from the group consisting of a keypad, a screen, a speaker, and a microphone.

26. The communication device of claim 22, wherein said communication device is selected from the group consisting of a smartphone, a laptop, a tablet, and a desktop computer.

27. The communication device of claim 22, wherein said logging and registration module is further configured to register said context state data in response to receiving a registration request from said device connection determination system.
